(19) United States
(12) Patent Application Publication
(10) Pub. No.: US 2007/0103391 A1
(43) Pub. Date: May 10, 2007

(54) Method of driving opposed discharge plasma display panel

(75) Inventors: Hsu-Pin Kao, Pingjhen City (TW); Jang-Jeng Liang, Taoyuan City (TW); Tsan-Hung Tsai, Sanchong City (TW); Sheng-Wen Hsu, Taipei City (TW); Hsu-Chia Kao, Pingjhen City (TW)

Correspondence Address: BACON & THOMAS, PLLC, 625 SLATERS LANE, FOURTH FLOOR, ALEXANDRIA, VA, 22314, US

(73) Assignee: MARKETECH INTERNATIONAL CORP., Taipei (TW)

(21) Appl. No.: 11/521,403

(22) Filed: Sep. 15, 2006

(30) Foreign Application Priority Data
Nov. 8, 2005 (TW) 094139052

(51) Int. Cl. G09G 3/28

(52) U.S. Cl. 345/60

(57) ABSTRACT

The present invention is to provide a method of driving an opposed discharge PDP comprising causing a driving circuit of the PDP to apply a sustaining pulse to each of a plurality of sustaining electrodes thereof for showing each of a plurality of sub-fields wherein a phase of the sustaining pulse of any of the sustaining electrodes is 180 degrees different from that of the sustaining pulse of the adjacent sustaining electrode, i.e. a waveform of odd number pixels is 180 degrees different from that of even number pixels in a sustaining period, enabling two adjacent discharge cells discharge in opposite directions so as to eliminate noise caused by vibration of the PDP in discharge, lower peak current and greatly decrease load on sustaining circuit and resulting in prolonging useful life of the circuit and increasing reliability of the circuit.

### FIELD OF THE INVENTION

The present invention relates to opposed discharge plasma display panels (PDPs), more particularly to a low noise and high efficient method of driving an opposed discharge PDP, where phase of a sustaining pulse applied to each sustaining electrode of the PDP is 180 degrees different from that of the sustaining pulse of the adjacent sustaining electrode, enabling adjacent two corresponding discharge cells to discharge in opposite directions so as to eliminate noise caused by vibration of the PDP in discharge and lower the peak current and electromagnetic interference.

### BACKGROUND OF THE INVENTION

A method of manufacturing a conventional opposed alternating current discharge (i.e., AC type) PDP 10 is illustrated in FIG. 1. First, two different layers are formed on two opposed glass substrates 11 and 12. Next, enclose each of the glass substrates 11 and 12. Also, a specific gas (e.g., helium (He), neon (Ne), xenon (Xe), or argon (Ar)) is mixed in a predetermined ratio and is filled in a discharge cell 13 between the glass substrates 11 and 12. The substrate facing a viewer is defined as a front substrate 11 in the PDP as shown in FIG. 1. Within the front substrate 11 there are provided, from inside to its surface, a plurality of parallel transparent electrodes 111, a plurality of bus electrodes 112, a dielectric layer 113, and a protection layer (e.g., MgO) 114. Within the opposed rear substrate 12 there are provided, from inside to its surface, a plurality of parallel data electrodes 121, a dielectric layer 124, a plurality of barrier ribs 122, and phosphor 123 uniformly coated on each of the barrier ribs 122 in which the phosphor 123 can be a red, green, or blue phosphor. In response to applying voltage to the positions of electrodes 111, 112, and 121 the corresponding dielectric layers 113 and 124 discharge in the discharge cell 13 formed between the adjacent barrier ribs 122. As a result, light with a corresponding color is emitted by the phosphor 123.

Referring to FIGS. 1 and 2, in the conventional AC type PDP 10, for electrodes of the front substrate 11 it is typically of sputtering on or subjecting photolithography to inside of the front substrate 11 to form a plurality of spaced, parallel transparent electrodes 111. Next, sputtering (or vaporing) on and subjecting photolithography (or printing) on the transparent electrodes 111 to form a plurality of bus electrodes 112. Line impedance of the transparent electrodes 111 is thus decreased by the bus electrodes 112. The transparent electrodes 111, the bus electrodes 112, and the corresponding data electrodes 121 in the rear substrate 12 together form two opposed electrodes. In response to applying voltage to the electrodes 111 and 121 the dielectric layers 113 and 124 perform an opposed discharge in the corresponding discharge cell 13. As a result, mixed gas filled in the discharge cell 13 discharges to emit ultraviolet (UV) rays. And in turn, red, green, and blue light is emitted by the phosphor 123 coated on the discharge cell 13. As a result, an image is shown. The conventional AC type PDP 10 is also called as opposed discharge PDP.

Referring to FIGS. 1 and 2 again, in the above opposed discharge PDP 10 the parallel data electrodes 121 of the rear substrate 12 are provided on bottom of the dielectric layer 124 and are disposed perpendicularly to the corresponding transparent electrodes (also called as scan electrodes or sustaining electrodes) 111 of the front substrate 11 about the discharge cell 13. Top of the dielectric layer 124 is formed as a protection layer (e.g., MgO) 125. A shadow mask 20 is formed on the protection layer 125. A plurality of compartments 21 of the shadow mask 20 are employed as space for the discharge cell 12. Also, metal conductor around each compartment 21 is served as barrier rib 122 around the discharge cell 13. Further, phosphor 123 is coated on wall of each cell-shaped barrier rib 122 in the corresponding discharge cell 13 formed around the barrier ribs 122. As such, coating area of the phosphor 123 is increased significantly, resulting in a great increase of light emitting efficiency of the PDP 10.

Referring to FIGS. 1, 2, and 3, in the above opposed discharge PDP 10 a driving scheme is created by a driving circuit of the PDP 10 for showing each sub-field. The driving scheme comprises three driving periods (i.e., a first addressing period, a second sustaining period, and a third erasing period). The driving circuit applies a negative voltage pulse to each transparent electrode 111 in the addressing period. At the same time, the driving circuit applies a positive data pulse to the address electrode 121 based on an image to be displayed. At this time, electric field in the discharge cell 13 becomes non-uniform due to the conductive metal material forming the shadow mask 20. That is, electric field adjacent wall of the compartment 21 (i.e., barrier rib 122) is relatively strong and electric field at a center of the compartment 21 is relatively weak. Discharge first occurs at wall of the compartment 21 when an addressing pulse is applied to the discharge cell 13. Also, charged particles in the discharge cell 13 quickly spread and propagate toward the center of the compartment 21 so as to induce an opposed discharge between the transparent electrodes 111 and the data electrodes 121. The opposed discharge scheme not only greatly increases light emitting efficiency of the PDP 10 but also obtains advantages such as high contrast, high writing speed, and low cost.

However, in the above opposed discharge PDP 10 the barrier rib 122 of the rear substrate 12 is formed of metal conductor around each compartment 21 of the shadow mask 20. Noise generated by the metal barrier rib 122 is far more serious than that generated by a barrier rib formed of the well known glass substrate when discharge occurs in the discharge cell 13. Moreover, referring to FIG. 3 again, for the above opposed discharge PDP 10 in the sustaining period a phase of the sustaining pulse of the nth scan electrode is the same as that of the sustaining pulse of the n+1th scan electrode. That is, phase of the odd number pixels and that of the even number pixels are the same with respect to voltage shape in the sustaining period. Thus, spreading direction (i.e., vibration direction) of noise generated by the discharge cells 13 in the discharge is the same. As a result, noise is significantly serious. It is found that gap is formed between an inner surface of the front substrate and the shadow mask if an intimate contact therebetween is not made in the process of manufacturing the opposed discharge PDP 10. And in turn, the gap further deteriorates the noise problem. Thus, it is desirable to strictly control flatness of the front and rear substrates and the shadow mask in order to decrease gap created due to irregularity between the front substrate and the shadow mask in the manufacturing process. The decreased gap can effectively decrease the noise problem. However, such strict control results in a great increase of process difficulty and a decreased yield.

### SUMMARY OF THE INVENTION

After considerable research and experimentation, a method of driving an opposed discharge plasma display panel (PDP) according to the present invention has been devised so as to overcome the above drawback (i.e., noise generated by the gap between the front substrate and the shadow mask) of the prior art.

It is an object of the present invention to provide a method of driving an opposed discharge PDP comprising causing a driving circuit of the PDP to apply a sustaining pulse to each of a plurality of sustaining electrodes of the PDP for showing each of a plurality of sub-fields wherein a phase of the sustaining pulse of any of the sustaining electrodes is 180 degrees different from that of the sustaining pulse of the adjacent sustaining electrode. That is, a waveform of odd number pixels is 180 degrees different from that of even number pixels in a sustaining period. By utilizing this method, discharge directions of two adjacent discharge cells are opposite so as to eliminate noise caused by vibration of the PDP in discharge.

In one aspect of the present invention a waveform of the sustaining pulse of any of the sustaining electrodes is 180 degrees delayed from that of the sustaining pulse of the adjacent sustaining electrode so as to cause discharge directions of two adjacent discharge cells to be opposite for eliminating vibration of the PDP in discharge.

In another aspect of the present invention a waveform of the sustaining pulse of any of the sustaining electrodes is inverse to that of the sustaining pulse of the adjacent sustaining electrode so as to cancel vibration generated by two adjacent discharge cells in discharge for eliminating noise caused by the vibration.

In a further aspect of the present invention a waveform of the sustaining pulse of an adjacent sustaining electrode remains negative if a waveform of the sustaining pulse of any of the sustaining electrodes remains positive. Current of the positive sustaining electrode flows from a front substrate to a rear substrate when the positive sustaining electrode is discharging. To the contrary, current of the negative sustaining electrode flows from the rear substrate to the front substrate when the negative sustaining electrode is discharging. Thus, peak current as required by the opposed discharge PDP according to the present invention is about one half as required by the opposed discharge PDP according to the prior art in discharge. The opposed discharge PDP of the present invention thus has the following advantages by lowering the peak current. Load on sustaining circuit is greatly decreased, resulting in a decrease of operating temperature of the circuit, a prolonging of useful life of the circuit, and an increase of reliability of the circuit. Cost is greatly decreased by lowering required current of the circuit. Load on switches is lowered, resulting in a further reduction of the generation of noise in switching the switches and electromagnetic interference.

In yet further aspect of the present invention a phase of current of one sustaining electrode is 180 degrees different from that of current of the adjacent sustaining electrode in discharge. That is, current of one sustaining electrode flows in a direction opposite to that of the adjacent sustaining electrode. The opposite current thus can eliminate electromagnetic emission generated in discharge, resulting in an effective decrease of electromagnetic interference.

The above and other objects, features and advantages of the present invention will become apparent from the following detailed description taken with the accompanying drawings.

### BRIEF DESCRIPTION OF THE DRAWINGS

FIG. 1 is a sectional view of a conventional opposed discharge PDP;

FIG. 2 is an exploded perspective view of the PDP of FIG. 1 showing its front and rear substrates;

FIG. 3 is a graph of a driving scheme created by a driving circuit of the PDP of FIG. 1 for showing each sub-field;

FIG. 4 is a graph of a driving scheme created by a driving circuit according to a first preferred embodiment of the invention for showing each sub-field;

FIG. 5 is a graph of a driving scheme created by a driving circuit according to a second preferred embodiment of the invention for showing each sub-field; and

FIG. 6 schematically depicts an opposed discharge between two adjacent discharge cells in discharge according to either preferred embodiment of the invention.

### DETAILED DESCRIPTION OF THE PREFERRED EMBODIMENTS

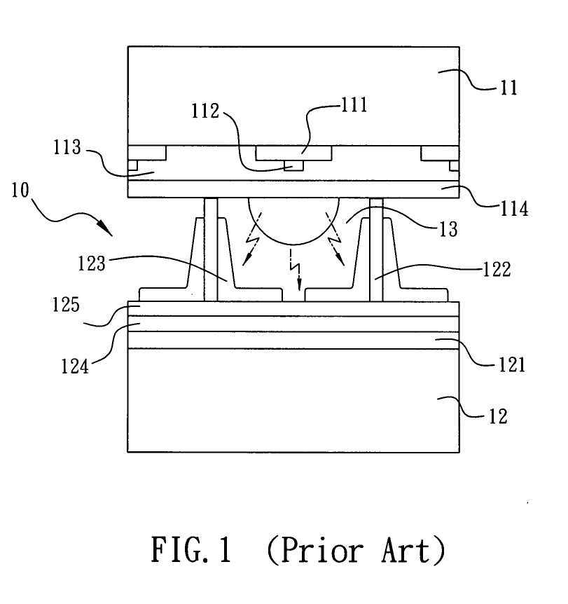

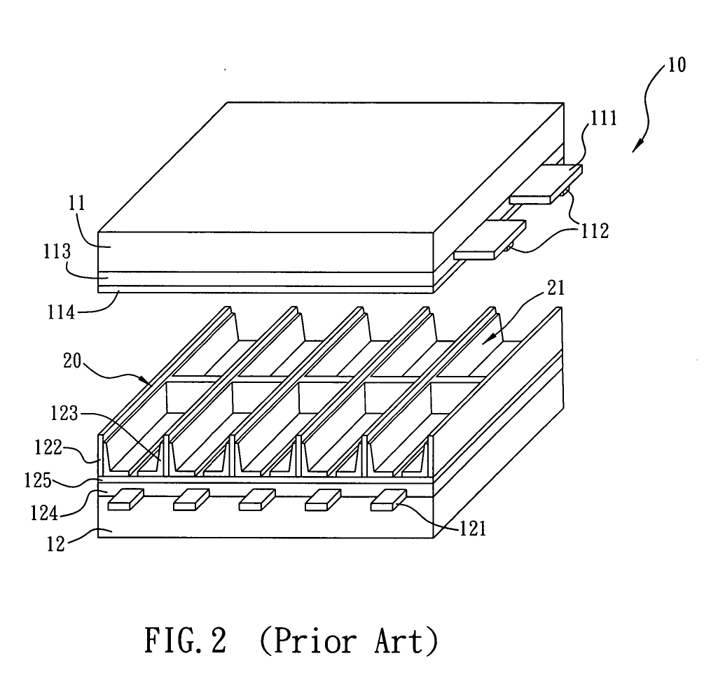

The invention is directed to a method of driving an opposed discharge PDP (see FIGS. 1 and 2) comprising causing a driving circuit of the PDP to apply a sustaining pulse to each of a plurality of sustaining electrodes of the PDP for showing each of a plurality of sub-fields wherein a phase of the sustaining pulse of the n+1^{th} sustaining electrodes is 180 degrees different from that of the sustaining pulse of the adjacent n^{th} sustaining electrode. That is, a waveform of odd number pixels is 180 degrees different from that of even number pixels in a sustaining period. By utilizing this method, discharge directions (i.e., vibration directions) of two adjacent discharge cells are opposite (i.e., cancelled each other) so as to eliminate noise caused by vibration of the PDP in discharge.

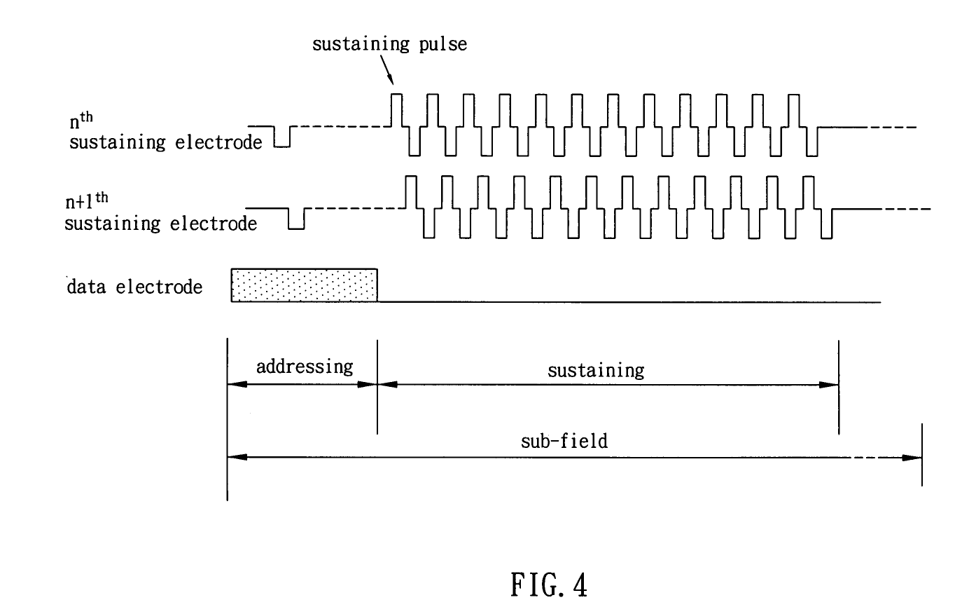

Referring to FIG. 4, in a first preferred embodiment of the invention the method of driving an opposed discharge PDP is illustrated. A driving scheme is created by a driving circuit of the PDP for showing each sub-field. The driving scheme comprises three driving period (i.e., a first addressing period, a second sustaining period, and a third erasing period). The driving circuit applies a negative voltage pulse to a sustaining electrode of the PDP in the addressing period. At the same time, the driving circuit applies a positive data pulse to an address electrode based on an image to be displayed. Next, the driving circuit applies a sustaining pulse to each of a plurality of sustaining electrodes of the PDP. Further, a waveform of the sustaining pulse of the n+1^{th} sustaining electrode is delayed ½ period relative to that of the sustaining pulse of the adjacent n^{th} sustaining electrode. That is, waveform of a discharge cell corresponding to the odd number pixels is delayed ½ period relative to that of a discharge cell corresponding to the even number pixels in the sustaining period. Thus, vibration direction of noise generated by the discharge cell is opposite to that of noise generated by the adjacent discharge cell in discharge. As an end, vibration is cancelled so as to effectively eliminate noise caused by the vibration of the PDP in discharge. Finally, the driving circuit applies an erasing pulse to each of the plurality of sustaining electrodes of the PDP in the erasing period. As such, wall charge of each discharge cell is eliminated after showing the last sub-field. In the embodiment waveform of a discharge cell corresponding to the odd number pixels is delayed ½ period relative to that of a discharge cell corresponding to the even number pixels in the sustaining period. Such driving method has advantages of without modifying driving scheme in reset period and addressing period.

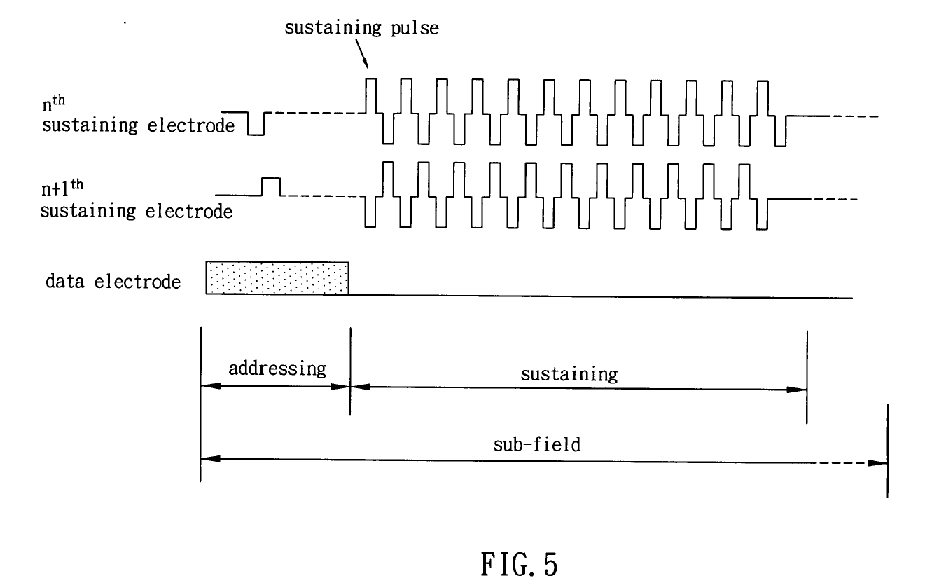

Referring to FIG. 5, in a second preferred embodiment of the invention the method of driving an opposed discharge PDP is illustrated. A driving circuit applies a sustaining pulse to a plurality of sustaining electrodes of the PDP for showing each sub-field in an addressing period. Further, a waveform of the sustaining pulse of the n+1^{th} sustaining electrode is inverse to that of the sustaining pulse of the adjacent n^{th} sustaining electrode. That is, waveform of a discharge cell corresponding to the odd number pixels is inverse to that of a discharge cell corresponding to the even number pixels in the sustaining period. Thus, vibration direction of noise generated by the discharge cell is opposite to that of noise generated by the adjacent discharge cell in the discharge. As an end, vibration is cancelled so as to effectively eliminate noise caused by vibration of the PDP in discharge.

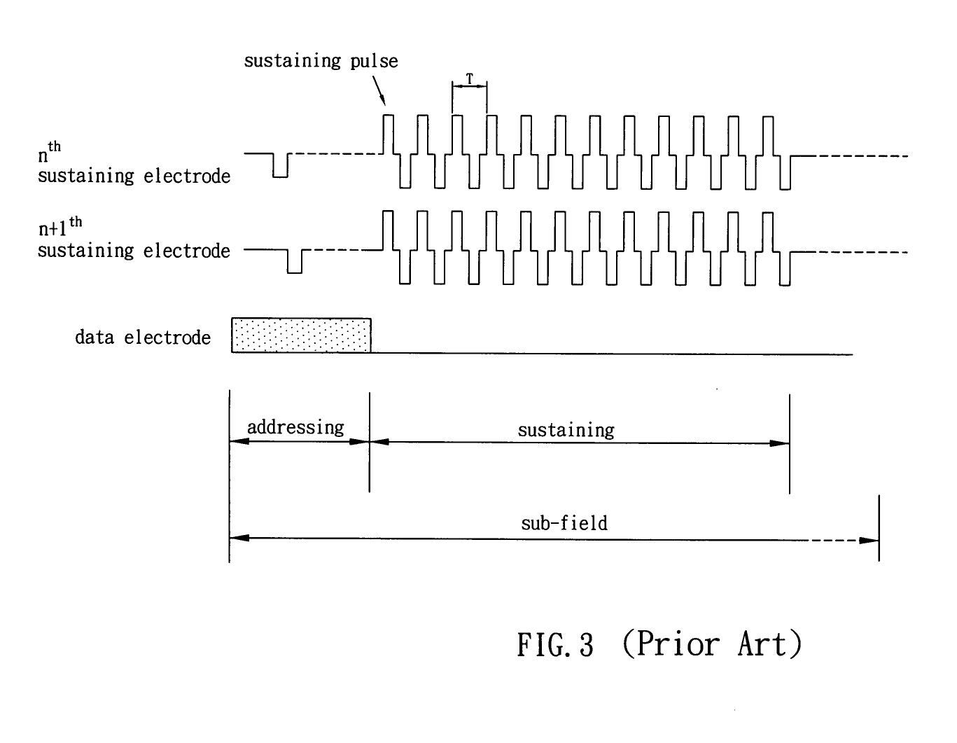

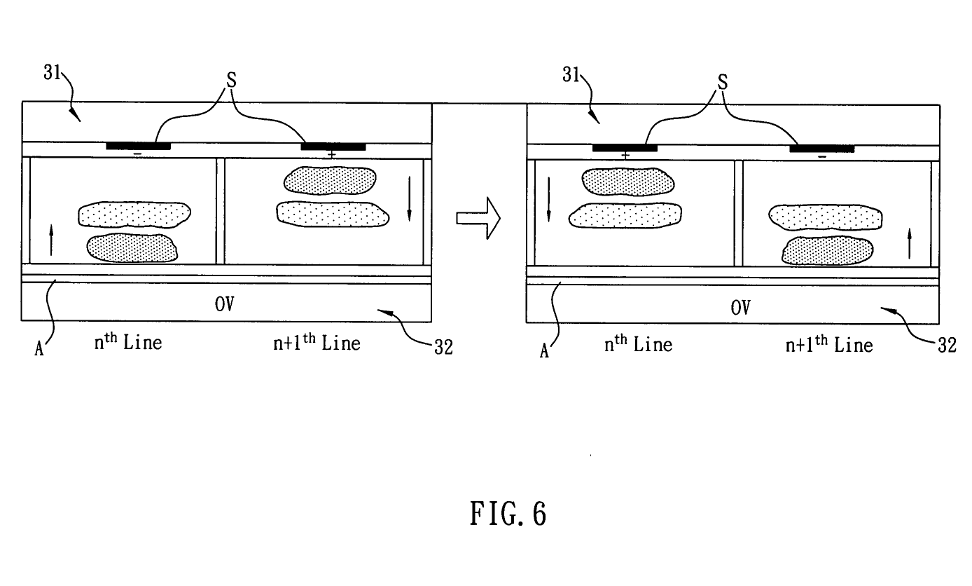

Referring to FIGS. 4 and 5 again, in either embodiment of the invention described above the driving circuit applies a sustaining pulse to a plurality of sustaining electrodes of the PDP for showing each sub-field in a sustaining period. At the same time a waveform of the sustaining pulse of the adjacent n^{th} sustaining electrode remains negative if a waveform of the sustaining pulse of the n+1^{th} sustaining electrode remains positive. Current of the positive sustaining electrode flows from a front substrate to a rear substrate when the positive sustaining electrode is discharging. To the contrary, current of the negative sustaining electrode flows from the rear substrate to the front substrate when the negative sustaining electrode is discharging. Thus, peak current as required by the opposed discharge PDP according to the invention is about one half as required by the opposed discharge PDP according to the prior art in discharge. For example, in an opposed discharge PDP having 640×480 resolution, in response to fully lighting a panel of the PDP 480 sustaining electrodes remain positive at a time t=a according to the prior driving method (see FIG. 3). A total current required by the panel in discharge is +480i if current is +i as required by each sustaining electrode (note that + means that current flows from the front substrate to the rear substrate). The 480 sustaining electrodes remain negative when a next discharge occurs at a time t=a+T/2. Thus, a total current required by the panel in discharge is −480i (note that − means that current flows from the rear substrate to the front substrate). Referring to FIG. 6, in a case of the driving method of the invention applied to the same panel, the new driving scheme will cause 240 sustaining electrodes S (i.e., indicated by n+1^{th} line of sustaining electrode) corresponding to the odd number pixels to remain positive and cause 240 sustaining electrodes S (i.e., indicated by n^{th} line of sustaining electrode) corresponding to the even number pixels to remain negative. Current of the positive sustaining electrode S flows from a sustaining electrode S of a front substrate 31 to a data electrode A of a rear substrate 32 when the positive sustaining electrode S discharges. To the contrary, current of the negative sustaining electrode S flows from the rear substrate 32 to the front substrate 31 when the negative sustaining electrode S discharges. 240 sustaining electrodes S (i.e., indicated by n+1^{th} line of sustaining electrode) corresponding to the odd number pixels remain negative and 240 sustaining electrodes S (i.e., indicated by n^{th} line of sustaining electrode) corresponding to the even number pixels remain positive when a next discharge occurs at a time t=a+T/2. Thus, a total current required by the panel is only +240i and −240 i in discharge. These current values are one half of peak current values +480i and −480i according to the prior art. The opposed discharge PDP of the invention thus has the following advantages by lowering the peak current. (i) Load on sustaining circuit is greatly decreased, resulting in a decrease of operating temperature of the circuit, a prolonging of useful life of the circuit, and an increase of reliability of the circuit. (ii) Cost is greatly decreased by lowering required current of the circuit. (iii) Load on switches is lowered, resulting in a further reduction of the generation of noise in switching the switches and electromagnetic interference.

Moreover, in both embodiments of the invention phase of current of one sustaining electrode is 180 degrees different from that of current of the adjacent sustaining electrode in discharge. That is, current of one sustaining electrode flows in a direction opposite to that of the adjacent sustaining electrode. The opposite current can eliminate electromagnetic emission generated in discharge, resulting in an effective decrease of electromagnetic interference.

While the invention herein disclosed has been described by means of specific embodiments, numerous modifications and variations could be made thereto by those skilled in the art without departing from the scope and spirit of the invention set forth in the claims.

What is claimed is:

1. A method of driving an opposed discharge plasma display panel (PDP) comprising:
causing a driving circuit of the PDP to apply a sustaining pulse to each of a plurality of sustaining electrodes of the PDP for showing each of a plurality of sub-fields wherein a phase of the sustaining pulse of the n+1^{th} sustaining electrode is 180 degrees different from that of the sustaining pulse of the n^{th} sustaining electrode.

2. The method of claim 1, wherein the driving circuit is adapted to create a driving scheme for showing each of the sub-fields, and the driving scheme comprises at least a first addressing period, a second sustaining period, and a third erasing period.

3. The method of claim 2, wherein the driving circuit applies a negative voltage pulse to each of the sustaining electrodes of the PDP in the addressing period and, at the same time, the driving circuit applies a positive data pulse to an address electrode of the PDP based on an image to be displayed.

4. The method of claim 2, wherein the driving circuit applies an erasing pulse to each of the plurality of sustaining electrodes of the PDP in the erasing period for erasing a wall charge of a discharge cell of the PDP.

5. The method of claim 1, wherein the driving circuit applies a sustaining pulse to each of the plurality of sustaining electrodes of the PDP in the sustaining period, and a waveform of the sustaining pulse of the n+1^{th} sustaining electrode is delayed ½ period relative to that of the sustaining pulse of the n sustaining electrode.

6. The method of claim 2, wherein the driving circuit applies a sustaining pulse to each of the plurality of sustaining electrodes of the PDP in the sustaining period, and a waveform of the sustaining pulse of the n+1^{th} sustaining electrode is delayed ½ period relative to that of the sustaining pulse of the n^{th} sustaining electrode.

7. The method of claim 3, wherein the driving circuit applies a sustaining pulse to each of the plurality of sustaining electrodes of the PDP in the sustaining period, and a waveform of the sustaining pulse of the n+1^{th} sustaining electrode is delayed ½ period relative to that of the sustaining pulse of the n^{th} sustaining electrode.

8. The method of claim 4, wherein the driving circuit applies a sustaining pulse to each of the plurality of sustaining electrodes of the PDP in the sustaining period, and a waveform of the sustaining pulse of the n+1^{th} sustaining electrode is delayed ½ period relative to that of the sustaining pulse of the n^{th} sustaining electrode.

9. The method of claim 1, wherein the driving circuit applies a sustaining pulse to each of the plurality of sustaining electrodes of the PDP in the sustaining period, and a waveform of the sustaining pulse of the n+1^{th} sustaining electrode is inverse to that of the sustaining pulse of the n^{th} sustaining electrode.

10. The method of claim 2, wherein the driving circuit applies a sustaining pulse to each of the plurality of sustaining electrodes of the PDP in the sustaining period, and a waveform of the sustaining pulse of the n+1^{th} sustaining electrode is inverse to that of the sustaining pulse of the n^{th} sustaining electrode.

11. The method of claim 3, wherein the driving circuit applies a sustaining pulse to each of the plurality of sustaining electrodes of the PDP in the sustaining period, and a waveform of the sustaining pulse of the n+1^{th} sustaining electrode is inverse to that of the sustaining pulse of the n^{th} sustaining electrode.

12. The method of claim 4, wherein the driving circuit applies a sustaining pulse to each of the plurality of sustaining electrodes of the PDP in the sustaining period, and a waveform of the sustaining pulse of the n+1^{th} sustaining electrode is inverse to that of the sustaining pulse of the n^{th} sustaining electrode.
